(19) United States
(12) Patent Application Publication
(10) Pub. No.: US 2012/0221353 A1
(43) Pub. Date: Aug. 30, 2012

(54) Medical Workflow Queue For Distributed Data Entry

(76) Inventors: Carl D. Dvorak, Verona, WI (US); Sumit Rana, Verona, WI (US); Joshua M. Brauer, Madison, WI (US); Samuel L. Butler, Madison, WI (US)

(21) Appl. No.: 13/033,968

(22) Filed: Feb. 24, 2011

(51) Int. Cl. G06Q 10/00; G06Q 50/00

(52) U.S. Cl. 705/3

(57) ABSTRACT

A system for facilitating patient data entry for mobile physicians provides for a task queue allowing partial data entry on different devices during the day according to the comparative advantage of the device. Thus, for example, a patient note may be prepared at an office terminal and some transcription added at a later time as dictated into a cell phone or the like. The queue structure provides informational cues to the physician to remind him or her of later data entry tasks and permits seamless integration of fragmented data entry into a common record.

### CROSS-REFERENCE TO RELATED APPLICATION

### FIELD OF THE INVENTION

The present invention relates to electronic medical records systems and, in particular, to a data entry system for physicians and other medical professionals providing improved workflow in clinical observations.

### BACKGROUND OF THE INVENTION

Considerable effort has been invested in improving the workflow of physicians to better leverage their skills. Much of this effort has been directed toward implementing electronic medical records to improve physician access to and sharing of medical data.

The value of electronic medical records can be further enhanced by reducing the burdens placed on physicians for data entry tasks. For this purpose, terminals may be placed directly in patient examination rooms allowing key data to be entered contemporaneously by the physician away from the physician's office. In addition, techniques such as dictation can be used to simplify the entry by a physician of observation notes into computer-readable text suitable for electronic record systems.

Dictation may not be practical in many situations, for example, in the presence of the patient where it would be distracting or confusing. Although most computers have some sound processing capability, dictation on a standard computer is often cumbersome and less than satisfactory, requiring special-purpose sound capture hardware, headsets or desktop microphones that are difficult to use and which clutter a workspace.

One method of simplifying data entry is by the use of “templates” that provide a framework for a patient note with “fill-in blanks”, for example, provided by menu lists that may be selected among by a physician. These templates can be “smart”, that is, informed by underlying information from electronic medical system database, so that the template is pre-populated with elements from the patient's record once the patient identification is entered. One limitation with templates is that they can be inflexible and poorly adapted recording unique observations related to a particular patient.

The mobile nature of a physician's practice in which the physician moves between patient examination rooms or makes rounds at a hospital, has led to increased interest in transferring the data entry process from a desktop environment to portable devices such as tablet computers. Current portable devices present a trade-off between portability and ease of data entry. For example, current touchscreen keyboards are a less efficient alternative than a standard keyboard and mouse combination for common text data entry, a problem exacerbated by the frequent lack of a stabilizing surface for the portable device that would permit easy two-handed typing. The size and clarity of the display for a portable device, in a range of different environments, is normally less than can be provided on a desktop machine in a fixed location and orientation. While the technology exists to increase the capabilities of portable devices, these modifications will still confront the inevitable tradeoff between portability and capability, with additional features likely to decrease portability both in terms of size (possibly eliminating the ability to place the device in a coat pocket or the like) and power usage (increases affecting the ability to operate the device over the entire workday on reasonably sized batteries).

### SUMMARY OF THE INVENTION

The present inventors have recognized that improved medical data entry workflow can be obtained by observing the comparative advantages of different data entry devices by permitting seamless transition between these devices during data entry. This seamless workflow between devices is made possible by a workflow queue which both identifies pending workflow and provides content descriptors and workflow state information allowing integration of data collected on two devices. The invention specifically may exploit the comparative advantages of sophisticated desktop workstations and highly portable devices such as smart phones. The former provides for greater processing power display and superior text entry and network communication, while the latter provides superior portability and audio processing. By recognizing the complementary strengths of each device, total workflow can be improved.

Specifically, the invention provides a multi-device workflow system for medical data entry using a first and second data entry device each having at least one data entry interface permitting a user to enter medical data, a communication channel interface permitting communication between the first and second data entry device; and a processor for executing application programs. At least one application program on the first data entry device executes to: (i) receive medical data entry from the user in a medical file; (ii) designate, in a workflow queue, additional medical data for the medical file for input on the second data entry device, the workflow queue further storing content descriptor for the additional medical data indicating at least one of a patient being a subject of the additional medical data and the medical file; and (iii) transmit the workflow queue to the second data entry device. At least one application program on the second data entry device executes to: (i) receive the workflow queue from the first data entry device;, (ii) display the content descriptor to the user for additional medical data entry; (iii) receive the additional medical data entry from the user linked to the content descriptor; and (iv) transmit the additional medical data as linked to the content descriptor to the first data entry device.

It is thus a feature of at least one embodiment of the invention to permit a single data entry task to be simply divided over multiple devices and times.

The application on the first data entry device may automatically open the medical file for acceptance of the additional medical data therein.

It is thus a feature of at least one embodiment of the invention to minimize the additional steps necessary when multiple devices are employed while preserving flexibility to provide data entry tasks for a variety of files.

The content descriptor may include at least one insertion point in the medical file for the additional medical data and the application on the first data entry device upon review of the additional medical data by the user, automatically inserts the additional medical data at the insertion point.

It is thus a feature of at least one embodiment of the invention to permit fine-grained division of data entry tasks even within a single medical file.

The data entry interface of the second device may be a microphone and the additional medical data may be dictation.

It is thus a feature of at least one embodiment of the invention to permit seamless intermixing of text entry on one device with dictation on a second device.

The second application program may transmit the additional medical data to the first data entry device via a transcriber.

It is thus a feature of at least one embodiment of the invention to employ the intercommunication between devices to provide intervening services such as transcription

The medical file may be a patient note describing a patient office visit.

It is thus a feature of at least one embodiment of the invention to improve common but critical patient note generation.

The first application program may receive medical data entry from the user in a medical file via a template having menu choices for adding data to the medical file and permitting free text entry for adding data to the medical file.

It is thus a feature of at least one embodiment of the invention to permit integration of a template system and dictation performed at different times.

The data entry interface of the second device may be a camera and the additional medical data is at least one digital photograph.

It is thus a feature of at least one embodiment of the invention to leverage the native ability of cameras with digital transmission capabilities to add images efficiently into medical records.

The second device may be a cellular phone.

It is thus a feature of at least one embodiment of the invention to incorporate medical data entry capabilities into a multipurpose device that may be normally carried by a physician.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a simplified block diagram of the principal components of an electronic medical record system communicating with a variety of different data entry terminal types such as may be used with the present invention;

FIG. 2 is a block diagram of two data entry devices linked by a workflow queue of the present invention;

FIG. 3 is a data flow diagram showing generation of the workflow queue upon initiation of data entry at a first data entry device;

FIG. 4 is a screen display of the workflow queue of FIG. 3 at a second data entry device receiving the workflow queue;

FIG. 5 is a figure similar to that of FIG. 3 showing initiation of a data entry task on a remote portable device and in particular the acquisition of photographs; and

FIG. 6 is a representation of two screen displays used to promote an understanding of the secure treatment of medical records entered through a remote device such as a cell phone.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof

### DETAILED DESCRIPTION OF THE PREFERRED EMBODIMENT

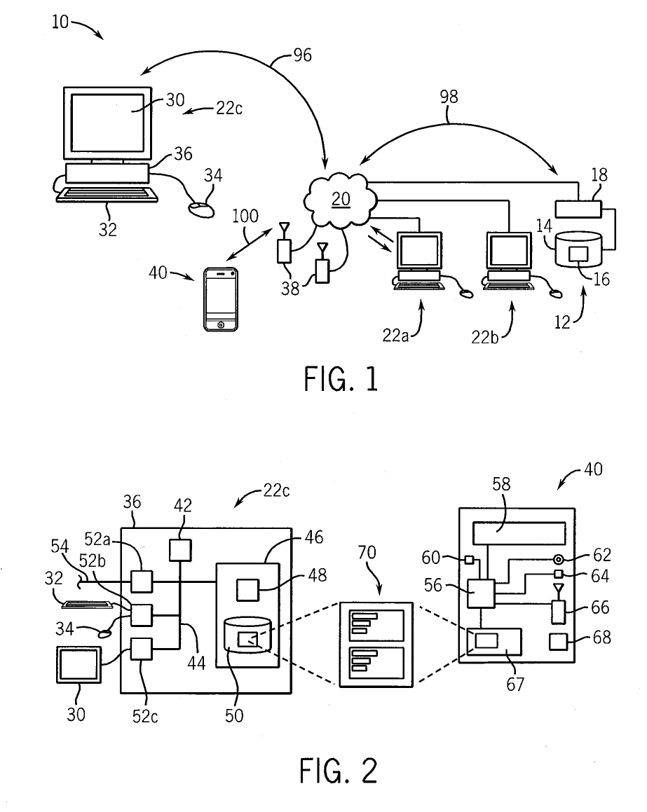

Referring now to FIG. 1, an electronic medical record system 10 may provide for a clinical database 12 providing a data storage system 14 holding a clinical record database 16 that may be served by an electronic medical record server 18 to a network 20. The electronic medical record server, for example, may be the EpicCare EMR manufactured by Epic Systems Corporation of Verona, Wis. As will be understood to those of ordinary skill in the art, a clinical record database 16 is one prepared under the supervision of healthcare professionals and having limited access per HIPAA requirements to provide a record keeping system on which health care decisions may be founded.

The network 20 may attach to various workstations 22a-22c providing secured access to the clinical record database 16 and containing stored application programs working in conjunction with the server 18 to permit reading and writing of the clinical record database 16 in a healthcare setting.

The workstations 22 are typically, but not necessarily, desktop or laptop computers or the like having a large area display screen 30 (for example a 15 inch diagonal or larger), a mechanical keyboard 32, and a mouse 34 or the like communicating with a processor/memory system 36. Workstation 22a, for example, may be used by a transcriptionist while workstations 22b and 22c may be in physician offices or the like.

The network 20 may also communicate with one or more access points 38, for example, providing a local area wireless network or a cellular telephone network, to provide for connection of wireless portable devices 40, for example tablet computers or cellular phones and in particular so called “smart” phones, permitting the installation of third-party applications.

Referring now to FIG. 2, a typical workstation 22c may provide for a processor 42 connected via an internal bus 44 with a memory 46 including, for example, volatile random access memory 48 and nonvolatile mass storage memory 50 such as flash memory or a hard disk drive. The bus 44 may also communicate with one or more interfaces 52a-52c communicating respectively with a network media 54, for example an Ethernet cable, the keyboard 32, mouse 34, and the screen 30.

The mobile device 40 may include a microcontroller 56 communicating with a display 58, for example a touchscreen display also permitting the entry of data, a microphone 60, a camera 62, a speaker 64, a radio transceiver 66, and a memory 67. The mobile device 40 may also include a battery system 68 providing power to the previously mentioned elements. Currently, suitable portable devices 40 may include the iPhone manufactured by Apple Computer or a similar cell phone running the Android operating system manufactured by Google.

The workstation 22c or mobile device 40 are provided by way of example to illustrate devices with contrasting capabilities such as currently exist in the medical environment. The mechanical keyboard 32, mouse 34, and large-screen 30 of the workstation 22c simplify and speed accurate data entry as well as the review of multiple sources of data. The greater power of the processor of the workstation 22c permits improved multitasking between different data accessing applications that may be held in the memory 46 and the network media 54 provides faster network data access. Generally, such workstations 22c are not well adapted for sound processing (either playing sound or recording sound) both as a result of technical limitations and also as a result of limitations imposed by the environment (e.g. desk space for microphones, difficulty in limiting the transmission of sound from speakers, lack of privacy, and lack of remote access). Workstations 22 may further be operatively precluded from effective sound processing when they are accessed remotely via systems such as Citrix which are designed to pass keystroke and video data to a remote terminal but cannot transmit or are less effective at transmitting audio data. In contrast, the mobile device 40, particularly in the case when the mobile device 40 is a cell phone, may have sophisticated sound handling components including microphone 60 and speaker 64 readily integrated into a housing which may be held near the user's mouth and ear or which may receive an earphone/microphone combination. In addition, portable devices 40 have high accessibility because they are portable and may be carried with the physician. Generally, however, data entry in the form of text is cumbersome on such portable devices 40.

It is contemplated that each workstation 22 will execute a program providing an authentication procedure to ensure only proper individuals can enter data into the clinical record database 16. It will be understood that similar authentication can be used on the mobile device 40; however, because the data from the mobile device 40, per the present invention, will be reviewed by a physician or other healthcare professional at a workstation 22, a high degree of authentication may not be required.

The present invention synergistically combines these data entry devices to provide a more versatile yet seamless data entry experience for the physician. The invention employs a workflow queue 70 that may be transferred between workstation 22c and mobile device 40 to permit data entry tasks to flexibly span these two devices and different times. Generally, the workflow queue 70 may be created on either workstation 22c or mobile device 40 when a data entry task is begun and then transferred to the other workstation 22c or mobile device 40 for completion of that data-entry task.

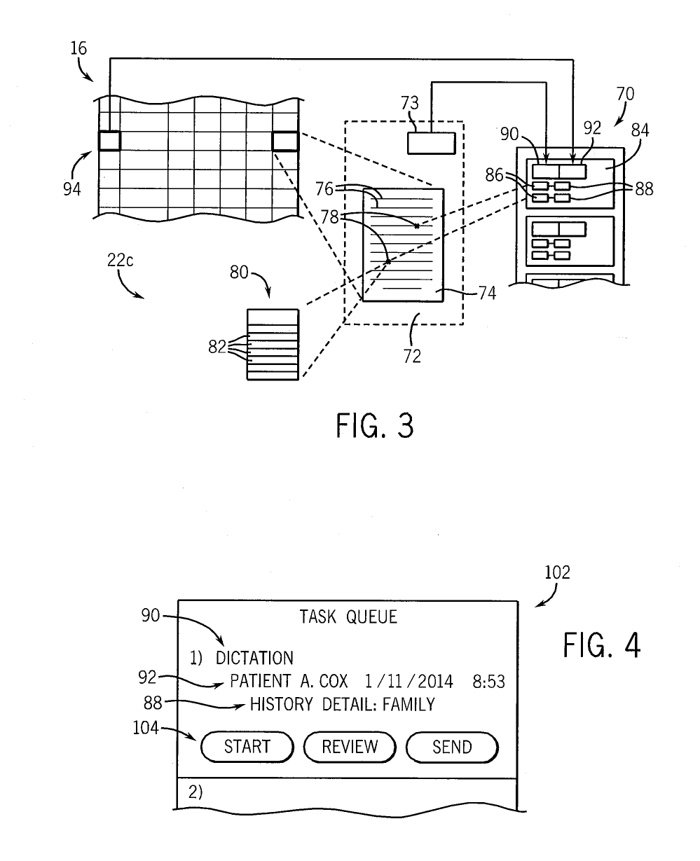

Referring now to FIG. 3, data entry on the workstation 22c may, for example, provide for a data entry program 72 executing on the workstation 22c for the creation of a medical document, in this case a patient note 74 being a prose description of the patient visit. The patient note 74 may be prepared by the physician, for example, using a template which provides a skeletal text framework having blanks that may be filled in manually or through the assistance of pulldown menus providing different choices for the blanks. The entries in some of the blanks may be used to automatically populate other blanks making use of linkages between data found in the clinical record database 16 as may be read by the data entry program 72. For example, entry of a patient identifying information may automatically populate entries related to the patient age, gender, etc taken from the clinical record database 16.

The result of selections in data entry by the physician is a medical file having lines of text 76. At various points within the text 76, the physician may opt to dictate text entries not well accommodated by the template structure. These points may be marked with flags 78 which, for example, may be indicated graphically by a character embedded in the text 76 visible to the physician on the screen 30. Upon the entry of a flag 78, a menu 80 may be provided with choices 82 denoting generally the content description of the text, for example, “additional patient history”. The content description will provide a reminder to the physician at the time of later data entry what additional data needs to be collected.

At the time of the opening of the data entry program 72 and the selection of a choice 82, a workflow queue 70 may be created that will be populated with a pointer 86 to each flag 78 linked to a content descriptor 88 identifying the needed additional data. For example, the content descriptor 88 may be the choice 82 taken from the menu 80 and describing the dictation that needs to be added at these points.

The queue entry 84 will also receive task information 90 indicating the data entry program 72 for which this data is required. This task information 90 may be derived from the data entry program 72 itself and program state information 73. The task information 90, for example, may include the name of the data entry program 72 (for example, represented by a path and executable file name) necessary to invoke the data entry program 72 and may include state data necessary to initialize the data entry program 72 to the point of data entry, as well as identify the document path for the patient note 74 to be generated. The queue entry 84 may also include command line information or context information 92 generally indicating the patient record 94 in the clinical record database 16 for which the data entry program 72 has been invoked providing, for example, patient ID information and information with respect to the field to which the patient note 74 belongs as one record field. In FIG. 3, the database records are indicated by rows and fields by columns according to conventional abstraction. Together, the pointer 86, the task information 90 and the context information 92 provide state information about the state of the data entry program 72 necessary to permit insertion of additional data at the flags 78.

It will be understood that some of this data may be derived from other of the data through, for example, reference to the clinical record database 16. The queue entry 84, therefore, need not physically hold this data directly provided the necessary data can be derived from information of the queue entry 84.

The workflow queue 70 may have multiple queue entries 84 related to different patients and different data entry programs 72 as may be generated by the physician over a period of time. Different workflow queues 70 may be provided for different physicians.

Referring again to FIGS. 1 and 2, the workflow queue 70 may be maintained on the workstation 22c and transferred from the workstation 22c to the network 20 as indicated by arrow 96 or be maintained on the server 18 and transferred from server 18 to the network 20 as indicated by arrow 98, and ultimately to the mobile device 40 per arrow 100. This transfer may be invoked by the mobile device 40 by the physician at a later time.

Referring to FIG. 4, an application program executed on the mobile device 40 may then provide for a graphic representation 102 on display 58 representing each queue entry 84. The graphic representation 102 may provide a human readable representation of the task information 90 and the context information 92 for each queue entry 84. In this case, that representation includes a patient name, date, and time suitable to identify the patient associated with the patient note 74. The data entry program 72 (that of creating a patient note) is implicit in this example. The graphic representation 102 may also include a text representation of the content descriptor 88 identifying the additional information required. In this case, the need for dictation may be inferred from the task information 90 or explicitly denoted by the content descriptor 88, causing the application program to provide dictation control buttons 104 or to call an appropriate dictation application program. In this example, the dictation control buttons 104 provide for a start (and stop), a review, and a send function which operate together to allow dictation to be recorded, played back for review. Other function buttons such as those that allow editing or trimming of the dictation can also be provided.

In one embodiment, pressing the send button may forward the dictation to workstation 22a for transcription and from there, ultimately, to workstation 22c. This may be accomplished within the confines of the electronic record system 10 by storing the audio data as a file on the centralized server 18 or another similar server. From there, a transcriptionist may link to the file from their workstation 22a and transcribe and enter the text into the clinical record database 16. Alternatively, the recording may be sent to a third party transcription service via a secure internet connection or the like. The third party transcriptionist or text to speech conversion program may then send the transcribed text back to the clinical record database automatically, or optionally via an operator at a terminal 22 who may enter it into the clinical record database 16.

The dictated additional data is inserted into the queue entry 84 associated with pointer 86 (or otherwise linked to this data) so that upon completion it may automatically be re-inserted into the partially completed data entry of the patient note 74 using the application identified by the queue entry 84 and the pointer 86 for placement of the transcribed text into the patient note 74. In this way, the physician may use the superior sound recording qualities of the mobile device 40 as well as its ability to be used in a private location to complete sensitive or detailed dictation.

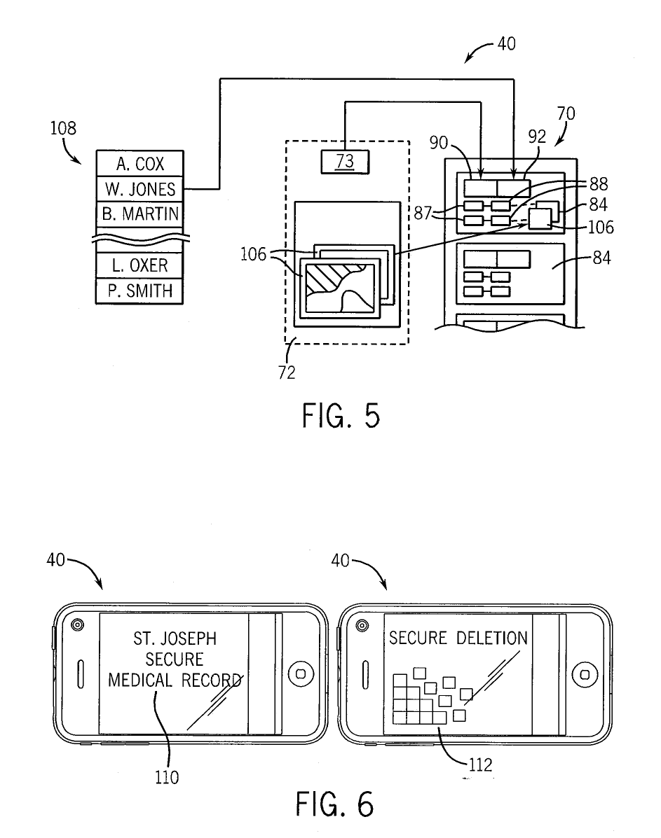

Referring now to FIG. 5, an equally valuable allocation of data entry tasks can occur driven by data first collected at the mobile device 40, for example, from the physician making rounds at a hospital and collecting information that may be incorporated into the medical record or patient note yet to be generated. In a data entry program 72 the physician, for example, may use dictation as described before or text entry or the superior capabilities of the mobile device 40 for photography, the latter to take one or more photographs 106 of the patient. The photographs 106, for example, may generate a queue entry 84 providing a picture identifier 87 to the particular photograph linked to photograph content descriptor 88. The photograph content descriptor 88 may be a text label provided by the physician or, at a minimum, the time and date of the photograph. The queue entry 84 is tagged with the task information 90 and context information 92, as before. In this case, the context information may be obtained from a locally held round list 108 listing patients to be visited by the physician. It is contemplated that individual patients on the round list 108 may be automatically selected, for example, through use of proximity signals in the particular patient room, for example, from an RFID tag bar code or local transmission as the physician visits those patients. Alternatively, the round list 108 may be downloaded from the electronic medical record system and a patient manually selected by the physician.

In this case, the task information 90 may identify the photography application used to create the photographs 106 but alternatively, or in addition, may identify a companion task of data entry at the workstation 22c that would receive such information and that may be implicit in the photography application. In this way, when the workflow queue 70 is transferred back to the workstation 22c, when the queue entry 84 is invoked on the graphic representation 102, it may open in the desired data entry application for receiving the photographs with command line arguments bringing up the desired patient records from the context information 92. Photographs acquired remotely can be readily integrated into the patient record by the physician. The companion task may be inferred from the data collected and the task information 90. Alternatively, the companion task may be expressly selected from a menu or the like (not shown).

The present invention also contemplates that a given queue entry 84 may automatically spawn additional queue entries 84 according to a set of rules or tasks automatically invoked by the selection of a first companion task. For example, a physician may begin a patient note in a hospital room invoking a first queue entry 84 for later completion of the patient note 74 at the physician's full workstation 22c. This queue entry 84 may invoke a second queue entry 84 linked to a different companion task of entering a charge for the patient visit in a billing program also at the physicians workstation 22c. This second queue entry 84 may identify a billing program in the task information 90 but may otherwise use identical or similar data for the context information 92. The content descriptor 88 may be automatically generated from the context or from the menu used to identify the first companion task.

When the physician returns to his or her workstation 22c, a graphic representation 102 of queue entries will show representations of two queue entry 84: one for completion of the patient note 74 in the data entry program 72, and the second for completion of the billing information in a billing program, for example, by entering billing codes or the like. Selection of the representation of the second queue entry 84 will open a billing entry for the particular patient possibly partially populated with the content descriptor 88. Alternatively, this billing task completion may be forwarded to another workstation 22a for completion by a nonphysician specialist.

Referring to FIG. 6, the present inventors recognize that the benefits of using a common cell phone for medical data entry carries with it a risk of patient concern about confidentiality. Such concerns are allayed first by providing secure communication between the mobile device 40 and the network 20, by proper authentication of the user by the application on the mobile device 40 assuring access only by appropriate healthcare professionals, and second by providing visual confirmation to the patient with respect to proper treatment of the acquired information. Accordingly, the present invention may provide a first display screen 110 visible on the mobile device 40 prior to data acquisition, for example, that may be shown to the patient to indicate the running of a secure medical data acquisition program. This display screen may, for example, show the logo of the healthcare institution and clearly indicate that the mobile device 40 is being used as a secure medical record entry device. In the case of photographs, upon sending of the photographs, a display 112 depicting destruction of the photograph may be used to provide visual confirmation to the physician and patient of the full erasure of the data from the mobile device 40. The application may provide for a limited duration of storage to ensure data is not retained on the portable device beyond a predetermined period in the event that the mobile device 40 is lost and improperly read. This confirmation may be accompanied by or supplanted by an audible tone or spoken message.

It will be appreciated that the mobile device 40 may be used not simply for photographs or dictation but may also be used for the entry of quantitative information that may be obtained during rounds by the physician, this information to be imported into the patient record or patient notes at a later time. Such information can include vital readings such as blood pressure and temperature, observed information, results of lab tests transferred manually, and the like. The photographs or other information may be attached to the generated queue entry 84 or sent separately and linked to the queue entry 84.

In one embodiment, the originally opened template may automatically generate additional medical data collection tasks for the mobile device 40 so that the collection data may precede actual generation of the patient note by a physician. In this case, the photographs may be cued by an automatically generated queue.

Generally, the term “queue” should not be considered to require any particular data structure but only data that provides for the functionality described above. When the terms “physician” or “doctor” are used herein, they should be considered to include healthcare professionals generally, including nurses and physician assistants.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a server” and “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network. It should be understood that a computer program may embrace constituent programs and that multiple programs may be implemented as a single or multiple programs.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A multi-device workflow system for medical data entry comprising:
(a) a first and second data entry device each providing:
(i) at least one data entry interface permitting a user to enter medical data;
(ii) a communication channel interface permitting communication between the first and second data entry devices; and
(iii) a processor for executing application programs;
(b) at least one application program on the first data entry device executing to:
(i) receive medical data entry from the user in a medical file;
(ii) designate in a workflow queue additional medical data for the medical file for input on the second data entry device, the workflow queue further storing a content descriptor for the additional medical data indicating at least one of a patient being a subject of the additional medical data and a state of the medical file indicating at least an identity of the medical file for receiving the additional medical data; and
(iii) transmit the workflow queue to the second data entry device; and
(c) at least one application program on the second data entry device executing to:
(i) receive the workflow queue from the first data entry device;
(ii) display the content descriptor to the user for additional medical data entry;
(iii) receive the additional medical data entry from the user linked to the content descriptor; and
(iv) transmit the additional medical data as linked to the content descriptor to the first data entry device.

2. The multi-device workflow system for medical data entry of claim 1 wherein the application on the first data entry device automatically opens the medical file for acceptance of the additional medical data therein.

3. The multi-device workflow system for medical data entry of claim 1 wherein the content descriptor includes at least one insertion point in the medical file for the additional medical data; and
wherein the application on the first data entry device, upon review of the additional medical data by the user, automatically inserts the additional medical data at the insertion point.

4. The multi-device workflow system for medical data entry of claim 1 wherein the data entry interface of the second device is a microphone and the additional medical data is dictation.

5. The multi-device workflow system for medical data entry of claim 4 wherein the second application program transmits the additional medical data to the first data entry device via a transcriber.

6. The multi-device workflow system for medical data entry of claim 1 wherein the medical file is a patient note describing a patient office visit.

7. The multi-device workflow system for medical data entry of claim 1 wherein the first application program receives medical data entry from the user in a medical file via a template having menu choices for adding data to the medical file and permitting free text entry for adding data to the medical file.

8. The multi-device workflow system for medical data entry of claim 1 wherein the data entry interface of the second device is a camera and the additional medical data is at least one digital photograph.

9. The multi-device workflow system for medical data entry of claim 1 wherein the second device is a portable device powered operating on battery power.

10. The multi-device workflow system for medical data entry of claim 1 wherein second device is a cellular phone.

11. The multi-device workflow system for medical data entry of claim 1 wherein the first application program is a data entry program for an electronic medical record holding clinical data used for medical treatment by healthcare professionals.

12. A multi-device workflow system for medical data entry comprising:
(a) a first and second data entry device each providing:
(i) at least one data entry interface permitting a user to enter medical data;
(ii) a communication channel interface permitting communication between the first and second data entry devices; and
(iii) a processor for executing application programs; wherein the first data entry device is a portable device operating on battery power;
(b) at least one application program on the first data entry device executing to:
(i) receive medical data entry from the user;
(ii) link the medical data to a content descriptor indicating at least one of a patient being a subject of additional medical data and a state of the medical file indicating at least an identification of the medical file for receiving the additional medical data; and
(iii) transmit the medical data and content descriptor to the second data entry device; and
(c) at least one application program on the second data entry device executing to:
(i) receive the medical data and content descriptor from the first data entry device;
(ii) display a workflow queue indicating at least the content descriptor and an existence of the medical data;
(iii) automatically open a medical file for acceptance of the medical data therein based on the content descriptor.

13. The multi-device workflow system for medical data entry of claim 12 wherein the application on the first entry device further automatically inserts the additional medical data in the opened medical file upon receipt of an input from the user indicating that the user has reviewed the medical data.

14. The multi-device workflow system for medical data entry of claim 12 wherein the medical file is a patient note describing a patient office visit.

15. The multi-device workflow system for medical data entry of claim 12 wherein the medical data is a clinical observation of the patient including at least one of blood pressure, temperature, and laboratory results related to the patient.

16. The multi-device workflow system for medical data entry of claim 12 wherein the data entry interface of the second device is a camera and the additional medical data is at least one digital photograph.

17. The multi-device workflow system for medical data entry of claim 12 wherein second device is a cellular phone.

18. The multi-device workflow system for medical data entry of claim 12 wherein the second application program is a data entry program for an electronic medical record holding clinical data used for medical treatment by healthcare professionals.

19. A method of medical data entry across a first and second device each having a different data entry interface permitting a user to enter medical data, and communication channel interfaces permitting communication between the data entry device processors for executing application programs; the method comprising the steps of:
(a) receiving at the first data entry device medical data entry from the user in a medical file;
(b) designating in a workflow queue additional medical data for the medical file for input on the second data entry device, the workflow queue further storing a content descriptor for the additional medical data indicating at least one of a patient being a subject of the additional medical data and the medical file;
(c) transmitting the workflow queue to the second data entry device;
(d) displaying at the second device the content descriptor to the user for additional medical data entry;
(e) receiving at the second device the additional medical data entry from the user linked to the content descriptor;
(f) transmitting from the second device to the first device the additional medical data as linked to the content descriptor to the first data entry device; and
(g) automatically opening the medical file on the first device for acceptance of the additional medical data therein.

20. The method of claim 19 wherein the content descriptor includes at least one insertion point in the medical file for the additional medical data and the first data entry device automatically inserts the additional medical data at the insertion point.

21. The method of claim 19 wherein the data entry interface of the second device is a microphone and the additional medical data is dictation and further including the step of transmitting the additional medical data to the first data entry device via a transcriber transcribing the dictation into text.
